(19) United States
(12) Patent Application Publication
(10) Pub. No.: US 2007/0019700 A1
(43) Pub. Date: Jan. 25, 2007

(54) Method and apparatus for multiple, discrete wavelength laser diode pumping of solid state laser materials

(75) Inventors: Dallas N. Barr, Woodbridge, VA (US); John E. Nettleton, Fairfax Station, VA (US)

Correspondence Address: DEPARTMENT OF THE ARMY;CECOM LEGAL OFFICE, FORT BELVOIR, AMSEL-LG-BELV, 10235 BURBECK ROAD, FORT BELVOIR, VA, 22060-5806, US

(73) Assignee: UNITED STATES OF AMERICA AS REPRESENTED BY THE DEPT OF THE ARMY

(21) Appl. No.: 11/186,962

(22) Filed: Jul. 22, 2005

(51) Int. Cl. H01S 3/091; H01S 3/094; H01S 3/08; H01S 3/092

(52) U.S. Cl. 372/75; 372/70; 372/102

(57) ABSTRACT

Diode pumped solid state lasers normally require the temperature of the diodes to be controlled so that the diode laser wavelength will match a strong absorption line in the solid state material. This requires heating and cooling equipment that adds size, weight, cost and complexity to the laser design. For military lasers that must operate over a large temperature range but still must be carried by a soldier, the weight and cost issues are severe. The invention makes use of multiple wavelengths, Bragg grating reflectors, to force a diode laser to operate at discrete wavelengths matched to the desired absorption wavelengths of the solid state laser material. The multiple discrete wavelengths are chosen to span a range of temperatures larger than that which can be accommodated by a single wavelength grating. Thus, as the diode temperature varies, the pump wavelength will switch among preselected wavelengths to assure consistent and efficient pumping over a predetermined temperature range.

### GOVERNMENT INTEREST

The invention described herein may be manufactured, used, sold, imported, and/or licensed by or for the Government of the United States of America.

### FIELD OF INTEREST

The invention relates to laser diodes and more particularly to laser diodes used in laser applications such as laser rangefinders and laser designators.

### BACKGROUND OF THE INVENTION

Laser rangefinders and laser designators are becoming an increasingly vital component in high precision targeting engagements. The precise and accurate range to target information is an essential variable to the fire control equation of all future soldier weapons. This information is easily, and timely, provided by laser rangefinders.

The laser designator operator selects a target by placing the high energy laser beam onto the target. The laser beam on the target serves as a guide to a high precision munition. Unfortunately, current fielded laser systems are bulky, heavy and expensive. Many of these laser systems were developed with twenty year old laser technology and use flash lamp pumping.

Conventional diode pumped laser concepts are just now becoming practical for field use but still have much room for improvement in terms of weight and cost. However, these diode pumped solid state lasers normally require the temperature of the diodes to be controlled so that the diode laser wavelength will match a strong absorption line in the solid state material. This requires heating and cooling equipment that adds size, weight, cost and complexity to the laser design. For military lasers that must operate over a large temperature range but still must be carried by a soldier, the weight and cost issues are severe.

The present invention addresses these issues.

### SUMMARY OF THE INVENTION

Accordingly, one object of the present invention is to provide a low-cost, portable laser rangefinder or laser designator.

The invention makes use of multiple wavelengths, Bragg grating reflectors, to force the diode laser to operate at discrete wavelengths matched to the desired absorption wavelengths of a solid state laser material. The multiple discrete wavelengths are chosen to span a range of temperatures larger that can be accommodated by a laser diode with a single wavelength grating. Thus, as the diode temperature varies, the pump wavelength will switch among pre-selected wavelengths to assure consistent and efficient pumping over the desired temperature range.

### BRIEF DESCRIPTION OF THE DRAWINGS

These and other objects of the invention will become readily apparent in light of the Detailed Description Of The Invention and the attached drawings wherein:

FIG. 1 is a schematic drawing of a grating stabilized laser diode known in the prior art.

FIG. 2 is a schematic drawing of a volume Bragg grating stabilized laser known in the prior art.

FIG. 3 is a graph of the absorption of Nd:YAG.

FIG. 4 is a graph of the absorption of Nd:YLF.

FIG. 5 is a schematic diagram of the present invention.

### DETAILED DESCRIPTION OF THE INVENTION

The method and apparatus for multiple, discrete wavelength laser diode pumping of solid state laser materials of the invention makes the fabrication of a very compact laser range finder or designator feasible.

Diode lasers typically have temperature dependent wavelengths that vary by approximately 0.33 nm/C°. Although the gain curve of these lasers is broad, without wavelength control, the diode will lase near the center of the gain distribution as it shifts. Wavelength selection of diode lasers is well known and exploits this broad gain curve.

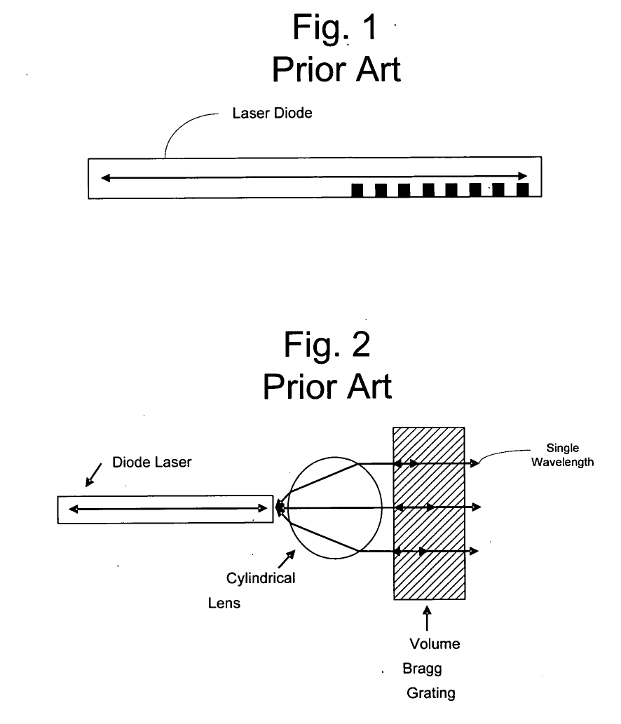

As shown in FIG. 1, distributed Bragg reflectors (DBR) and distributed feedback (DFB) diode lasers have a Bragg grating incorporated in the semiconductor laser cavity. Volume Bragg Gratings (VBGs) are also commercially available to select laser diode wavelengths with optics that are separate from the semiconductor but still part of the optical resonator. A VBG is shown in FIG. 2. To date, these single wavelength gratings can operate only over a range of about 30 degrees Centigrade. They are limited by the shift in diode wavelength caused by temperature changes because the shift can be larger than the diode gain line width.

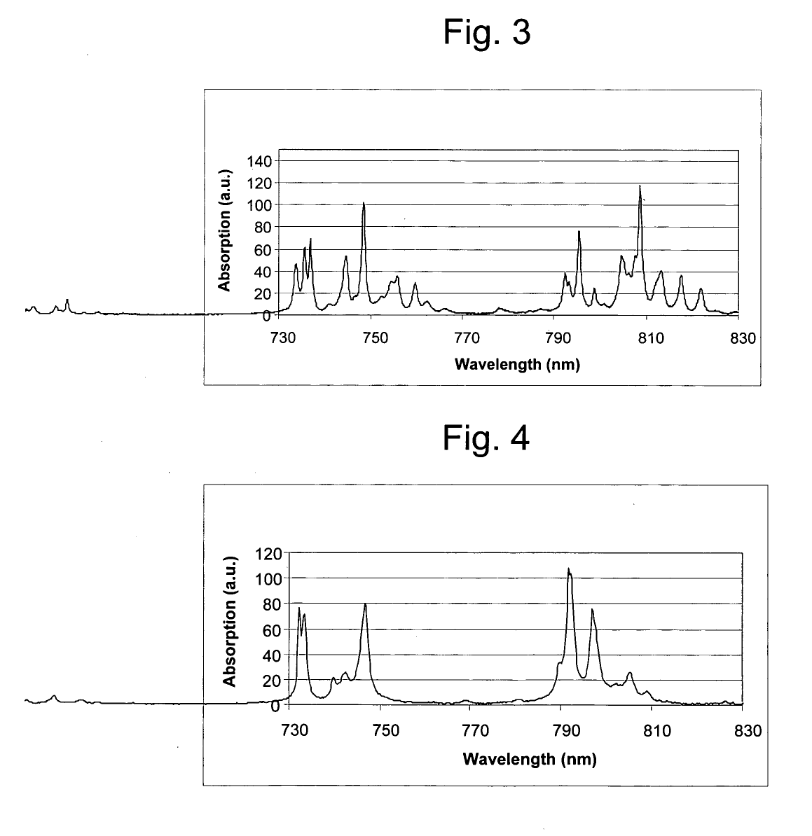

To allow pumping over large temperature ranges, the invention uses several wavelengths on the absorption spectrum of the solid state laser material that correspond to the expected temperature variation. For example, a common solid state material, Neodymium doped Yttrium Aluminum Garnet (Nd:YAG), has absorption lines near 800 nanometers (nm). As shown in FIG. 3, the absorption lines span a 90 nm range. Since the wavelength shift is approximately 0.33 nm/C° for commonly used Gallium Arsenide laser diode pumps, this offers a theoretical temperature range of nominally 273° C. Practical materials issues may limit this to a smaller range.

Those skilled in the art can select wavelengths to match desired points on the absorption spectrum with a minimum spacing of approximately 5-10 nm depending on the performance of the grating. For example, military requirements might range from −20 C to +40 C, a span of 60 C which corresponds to 20 nm of laser diode wavelength drift. A laser designer might choose three or four specific pump wavelengths, with similar absorption coefficients, in the range from 800 nm to 820 nm. (Note: these wavelengths will not necessarily be at the peaks.)

FIG. 4 shows the absorption spectrum of Neodymium doped LiYF4 (Nd:YLF) which has a different spectrum than Nd:YAG and thus a different set of diode laser wavelengths would be chosen. For Nd:YLF, the useful wavelength range is about 790 nm to 810 nm.

These are just examples of the absorption spectra of two common solid state laser materials. Those skilled in the art will recognize that many others are available and the diode laser operating wavelengths would be chosen on a material by material basis. The important aspect of the invention is to have a wavelength selection element, such as a volume diffraction grating made of glass that permits several different preselected wavelengths to pass on to the laser gain material. Depending on the temperature, the appropriate wavelength will pass through the wavelength selection element and lase within the gain material.

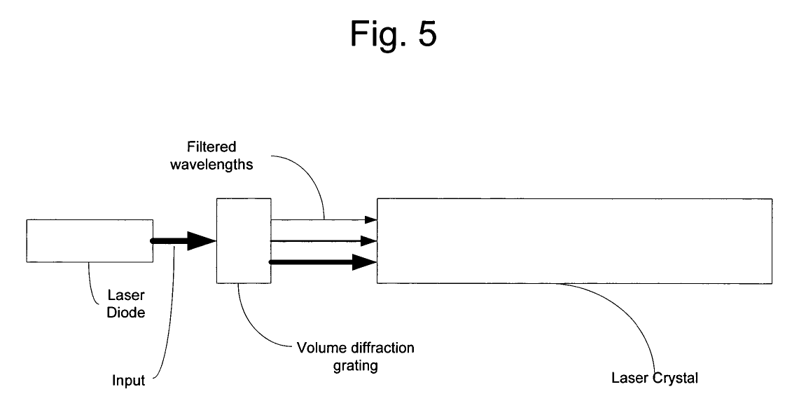

The invention is shown schematically shown in FIG. 5. As shown, a laser diode produces an input of a range of wavelengths. The input passes through a wavelength selection element so that only predetermined wavelengths of the input are passed through to the block of laser gain material. The predetermined wavelengths are selected such that the absorption remains essentially the same over the range of wavelengths.

The invention simplifies the producibility of laser range finder and laser designator systems. Instead of stabilizing a single pumping wavelength of the diode laser by controlling the diode temperature, the invention is a way that allows a set of wavelengths to be chosen and allows the temperature to vary freely with environmental changes. This eliminates the cost, weight and complexity problems associated with heating, cooling and controlling the diode laser temperature. Without the need for heating and cooling the overall prime power efficiency of the laser increases significantly. In addition, the choice of wavelengths gives the laser designer control of the solid state material absorption coefficient to match the absorption length of the laser design. For example, to achieve more uniformly distributed excitation one might choose a lower absorption coefficient for end pumping down the length of the solid state laser rod. If side pumping, wavelengths with higher absorption coefficients would be chosen due to the shorter available path length. In either case, the doping level of the crystal can be chosen to optimize the absorption coefficient for the design.

The present invention may be used for the laser source in very compact laser range finders or laser designators. Airborne laser radar systems that use diode pumped micro-chip lasers will benefit. Commercial, medical and space applications will also benefit from this technique by allowing for more electrical power efficiency and smaller, lighter and less complex designs.

What is claimed is:

1. A laser comprising:
A laser diode that produces an initial laser input
A wavelength selection means to filter the initial laser input to a plurality of selected wavelengths; and
A crystal of gain material being doped to have a predetermined absorption coefficient;
Wherein the plurality of selected wavelengths is selected so that the filtered initial laser input will lase in the gain material over a predetermined range of environmental temperatures.

2. The laser of claim 1 wherein the crystal of gain material is Nd:YAG.

3. The laser of claim 1 wherein the crystal of gain material is Nd:YLF.

4. The laser of claim 1 wherein the laser diode is made of GaAs.

5. A laser diode comprising:
A laser source input; and
A wavelength selection means being able to filter predetermined wavelengths matched to a desired absorption wavelengths of a solid state laser material of which the wavelength selection means is made;
Wherein the predetermined wavelengths are chosen to span a range of temperatures larger than can be accommodated by a single wavelength grating.

6. The laser diode of claim 5 wherein a pump wavelength will switch among the predetermined wavelengths such that the laser diode will operate over a predetermined temperature range.

7. The laser of claim 6 wherein the crystal of gain material is Nd:YAG.

8. The laser of claim 6 wherein the crystal of gain material is Nd:YLF.
